(19) United States
(12) Patent Application Publication
(10) Pub. No.: US 2025/0198933 A1
(43) Pub. Date: Jun. 19, 2025

(54) SPECTROSCOPIC ANALYSIS AND PARTICLE IDENTIFICATION USING OUT-OF-PLANE IMAGING OF MULTIMODE-INTERFEROMETER WAVEGUIDE SCATTERING

(71) Applicant: The Regents of the University of California, Oakland, CA (US)

(72) Inventor: Holger Schmidt, Capitola, CA (US)

(21) Appl. No.: 18/847,777

(22) PCT Filed: Mar. 24, 2023
(86) PCT No.: PCT/US2023/016188

§ 371 Date: Sep. 17, 2024

Related U.S. Application Data
(60) Provisional application No. 63/323,113, filed on Mar. 24, 2022.

(51) Int. Cl. G01N 21/65; B82Y 35/00; G01N 21/49; G01N 21/64

(52) U.S. Cl. CPC G01N 21/65; G01N 21/49; G01N 21/6428; G01N 21/6458; B82Y 35/00

(57) ABSTRACT

Systems and methods for spectroscopic analysis and particle identification using out-of-plane imaging of multimode-interferometer waveguide (MMI-WG) scattering are provided. A MMI-WG comprises an input end, a lateral surface, and an input port disposed on the input end, such that light in the MMI-WG propagates in a direction away from the input end. A sensor is configured to detect scattered light that scattered through the lateral surface of the MMI-WG, and to generate data based on the detected scattered light, wherein the data indicates an intensity of the scattered light. One or more processors are configured to determine, based on the intensity of the scattered light indicated by the data generated by the sensor, one or more wavelengths of the input light. The identity of one or more particles may be determined based on the one or more determined wavelengths.

### CROSS-REFERENCE TO RELATED APPLICATIONS

This application claims priority to and benefit of U.S. Provisional Patent Application No. 63/323,113, filed Mar. 24, 2022, the disclosure of which is hereby incorporated herein by reference in its entirety.

### FIELD

The present disclosure relates generally to multimode-interference waveguides (MMI-WG), and more particularly to performing spectrometry and particle identification using out-of-plane imaging of MMI-WG scattering.

### BACKGROUND

Multimode-interferometer waveguides (MMI-WG) are optical devices that are configured to transmit propagating light in a predictable manner so as to generate multimode interference patterns. A typical MMI-WG may have a flat rectangular prism (cuboid) shape, defined by an input end face, an output end face, two side faces, a top face, and a bottom face. The MMI-WG may be significantly wider in the dimension between the two side faces than it is in the direction between the top face and the bottom face. Light may propagate through the MMI-WG from the input end face toward the output end face. As the propagating light travels in different modes with different propagation speeds, the light may constructively and destructively interfere with itself to form spatially-distributed peaks and valleys of intensity. The spatially-distributed intensity peaks may form multimode spot patterns along various planes in the MMI-WG. These multimode spot-patterns may be coupled into MMI-WG output ports (e.g., disposed on the output end face) and imaged. The distance along the MMI-WG at which a particular multimode spot-pattern forms may depend on the MMI-WG index of refraction, the MMI-WG dimensions, the and the wavelength of propagating light.

### SUMMARY

As described above, MMI-WGs may be used to form multimode interference patterns of propagating light, wherein spatial intensity patterns may form spot patters at different planes along the direction of propagation of light in the MMI-WG. The location within an MMI-WG at which various spot patterns are formed may depend on the MMI-WG index of refraction, the MMI-WG dimensions, and the wavelength of propagating light. The spatial intensity patterns (e.g., spot patterns) formed in an MMI-WG may be imaged by coupling the propagating light into an output port formed on the output end face of the MMI, such that spot patterns as observed from within the “plane” of the MMI-WG (e.g., between the bottom face and the top face of the MMI) may be observed.

However, known approaches to imaging MMI-WG spot patterns have certain drawbacks. For example, because the distance (in the direction of propagation) along an MMI-WG at which different spot patterns resolve is dependent on the wavelength of propagating light, coupling spot patterns formed in an MMI-WG into in-plane output ports (e.g., for coupling into fiber(s)) may require that only a single wavelength of light can be effectively used for any given MMI-WG. Furthermore, resolving different spot patters may require a very long (in the direction of propagation) MMI-WG, such that patterns formed by different wavelengths that are close to one another can adequately separate. Moreover, creation and collection of well-resolved spot patterns using MMI-WGs requires precise fabrication and tuning.

Accordingly, there is a need for improved techniques for imaging multimode interference patterns formed in MMI-WGs. Particularly, there is a need for improved techniques for using waveguide systems to perform spectrometry by determining a spectrum (including one or more wavelengths) of light propagating in a waveguide without the need to collect a well-resolved in-plane spot pattern. Furthermore, there is a need for improved techniques for using imaging of light from an MMI-WG, and determination of the spectrum of said propagating light, to identify particles. Disclosed herein are systems and methods that may address one or more of the above-identified needs.

A system for MMI-waveguide based spectrometry is provided, wherein the system is configured to couple light of various wavelengths into an MMI-WG such that the light can propagate through the waveguide and form spatial interference patterns therein. Rather than (or in addition to) being configured for in-plane imaging of spot patterns formed in the MMI-WG, the system may be configured for out-of-plane imaging in which light that is scattered through the top face or bottom face of the MMI-WG is collected for imaging. For example, an image sensor may be disposed above or below the MMI-WG to collect the scattered light and to generate image data based on the scattered light collected. Even if the image data of the scattered light is only collected in a single color-channel, the spectrum of the light propagating through the MMI-WG (and scattered through the top or bottom face of the MMI-WG) may be determined based on spatial patterns in the intensity of the scattered light. For example, given predetermined knowledge of the MMI-WG's geometry and index of refraction, the spatial intensity pattern of the scattered light may be used to determine the spectrum of the light propagating in the MMI-WG. Additionally or alternatively, given predetermined knowledge of the MMI-WG's geometry and index of refraction, and given predetermined knowledge of a limited set of possible wavelengths of light that may be propagating in the MMI-WG, the spatial intensity of the scattered light at a single spatial location may be used to determine which wavelength(s) (of the limited possible set) is propagating in the MMI-WG.

The spectrometry techniques described herein may be used for particle identification. For example, light coupled into an MMI-WG may be light that was emitted from a particle, wherein the wavelength of the emitted light may be characteristic of the particle's identity. For example, fluorescent particles that emit fluorescence emission light in a characteristic wavelength, or quantum dots that emit light in a characteristic wavelength, or particles that scatter light via Rayleigh or Raman scattering, may be provided such that their emission light is coupled into an MMI-WG. The wavelength or wavelengths of the emission light may then be determined based on collection and analysis of out-of-plane scatter intensity data, and the determined wavelength or spectrum of the emission light may be used to determine the identity of the particle.

In some embodiments, a multimode-interferometric spectrometer is provided, comprising: a multi-mode interference waveguide (MMI-WG), comprising: an input end; a lateral surface; and an input port disposed on the input end of the MMI-WG and configured to guide input light to enter the MMI-WG, such that light in the MMI-WG propagates in a direction away from the input end; a sensor configured to detect scattered light that scattered through the lateral surface of the MMI-WG, and to generate data based on the detected scattered light, wherein the data indicates an intensity of the scattered light; and one or more processors configured to determine, based on the intensity of the scattered light indicated by the data generated by the sensor, one or more wavelengths of the input light.

In some embodiments of the multimode-interferometric spectrometer, the lateral surface comprises one of a top surface of the MMI-WG and a bottom surface of the MMI-WG.

In some embodiments of the multimode-interferometric spectrometer, the sensor is spaced apart from the lateral surface of the MMI-WG such that the scattered light propagates from the lateral surface of the MMI-WG through air to reach the sensor.

In some embodiments, the multimode-interferometric spectrometer comprises one or more optical elements configured to guide the scattered light to the sensor.

In some embodiments of the multimode-interferometric spectrometer: the sensor comprises a two-dimensional sensor configured to detect the scattered light scattered through the lateral surface of the MMI-WG; and the data generated by the sensor comprises a two-dimensional image based on the captured scattered light.

In some embodiments of the multimode-interferometric spectrometer, a portion of the lateral surface of the MMI-WG comprises a modified portion that enhances scattering at a location of the modified portion.

In some embodiments of the multimode-interferometric spectrometer, the modified portion comprises one or more of: an etched portion of the lateral surface; and a layer deposited onto the lateral surface.

In some embodiments of the multimode-interferometric spectrometer: input light of a first wavelength scatters at the location with an intensity above a predefined threshold; and input light of a second wavelength scatters at the location with an intensity below a predefined threshold.

In some embodiments of the multimode-interferometric spectrometer, the sensor is configured to detect the scattered light after scattering through the modified portion of the lateral surface of the MMI-WG.

In some embodiments of the multimode-interferometric spectrometer, determining the one or more wavelengths of the input light comprises determining whether the intensity of the scattered light exceeds a predefined intensity threshold.

In some embodiments of the multimode-interferometric spectrometer: the data generated by the sensor comprises a two-dimensional image; and determining the one or more wavelengths of the input light comprises applying a pattern-recognition operation to image.

In some embodiments, a method is provided, the method performed at a multimode-interferometric spectrometer comprising a sensor, one or more processors, and a multi-mode interference waveguide (MMI-WG), the method comprising: detecting, by the sensor, scattered light that scattered through a lateral surface of the MMI-WG, wherein the MMI-WG comprises: an input end; the lateral surface; and an input port disposed on the input end of the MMI-WG and configured to guide input light to enter the MMI-WG, such that light in the MMI-WG propagates in a direction away from the input end; generating, by the sensor, data based on the detected scattered light, wherein the data indicates an intensity of the scattered light; and determining, by the one or more processors, based on the intensity of the scattered light indicated by the data generated by the sensor, one or more wavelengths of the input light.

In some embodiments, a non-transitory computer readable storage medium is provided, the non-transitory computer readable storage medium storing instructions configured to be executed by one or more processors of a multimode-interferometric spectrometer comprising a sensor and a multi-mode interference waveguide (MMI-WG), the instructions configured to cause the system to: detect, by the sensor, scattered light that scattered through a lateral surface of the MMI-WG, wherein the MMI-WG comprises: an input end; the lateral surface; and an input port disposed on the input end of the MMI-WG and configured to guide input light to enter the MMI-WG, such that light in the MMI-WG propagates in a direction away from the input end; generate, by the sensor, data based on the detected scattered light, wherein the data indicates an intensity of the scattered light; and determine, by the one or more processors, based on the intensity of the scattered light indicated by the data generated by the sensor, one or more wavelengths of the input light.

In some embodiments, a system for particle identification is provided, comprising: an excitation light source configured to excite a particle and to cause the particle to emit emission light; a multi-mode interference waveguide (MMI-WG), comprising: an input end; a lateral surface; and an input port disposed on the input end of the MMI-WG and configured to guide the emission light emitted from the particle to enter the MMI-WG, such that the emission light in the MMI-WG propagates in a direction away from the input end; a sensor configured to detect scattered light that scattered through the lateral surface of the MMI-WG, and to generate data based on the detected scattered light, wherein the data indicates an intensity of the scattered light; and one or more processors configured to determine, based on the intensity of the scattered light indicated by the data generated by the sensor, an identity of the particle.

In some embodiments of the system for particle identification, the particle comprises a fluorescent molecule.

In some embodiments of the system for particle identification, the particle is fluorescently labeled.

In some embodiments of the system for particle identification, the particle comprises a quantum dot.

In some embodiments of the system for particle identification, the particle is labeled with one or more quantum dots.

In some embodiments of the system for particle identification, the particle scatters light via Rayleigh or Raman scattering.

In some embodiments of the system for particle identification, target particles that scatter light via Raman scattering are bound to a larger carrier particle.

In some embodiments, the system for particle identification comprises a fluid channel configured to hold a fluid medium in which the particle is disposed.

In some embodiments of the system for particle identification, the excitation light source is incident on the fluid channel to excite the particle.

In some embodiments of the system for particle identification, determining the identity of the particle comprises: determining, based on the intensity of the scattered light indicated by the data generated by the sensor, one or more wavelength of the emission light; and determining, based on the determined one or more wavelengths of the emission light, the identity of the particle.

In some embodiments of the system for particle identification, the lateral surface comprises one of a top surface of the MMI-WG and a bottom surface of the MMI-WG.

In some embodiments of the system for particle identification, the sensor is spaced apart from the lateral surface of the MMI-WG such that the scattered light propagates from the lateral surface of the MMI-WG through air to reach the sensor.

In some embodiments, the system for particle identification comprises one or more optical elements configured to guide the scattered light to the sensor.

In some embodiments of the system for particle identification: the sensor comprises a two-dimensional sensor configured to detect the scattered light scattered through the lateral surface of the MMI-WG; and the data generated by the sensor comprises a two-dimensional image based on the captured scattered light.

In some embodiments of the system for particle identification, a portion of the lateral surface of the MMI-WG comprises a modified portion that enhances scattering at a location of the modified portion.

In some embodiments of the system for particle identification, the modified portion comprises one or more of: an etched portion of the lateral surface; and a layer deposited onto the lateral surface.

In some embodiments of the system for particle identification: input light of a first wavelength scatters at the location with an intensity above a predefined threshold; and input light of a second wavelength scatters at the location with an intensity below a predefined threshold.

In some embodiments of the system for particle identification, the sensor is configured to detect the scattered light after scattering through the modified portion of the lateral surface of the MMI-WG.

In some embodiments of the system for particle identification, determining the one or more wavelengths of the input light comprises determining whether the intensity of the scattered light exceeds a predefined intensity threshold.

In some embodiments of the system for particle identification: the data generated by the sensor comprises a two-dimensional image; and determining the one or more wavelengths of the input light comprises applying a pattern-recognition operation to image.

In some embodiments, a method is provided, the method performed at a particle identification system comprising an excitation light source, a sensor, and a multi-mode interference waveguide (MMI-WG), the method comprising: exciting, by the excitation light source, a particle to cause the particle to emit emission light; detecting, by the sensor, scattered light that scattered through a lateral surface of the MMI-WG, wherein the MMI-WG comprises: an input end; the lateral surface; an input port disposed on the input end of the MMI-WG and configured to guide the emission light emitted from the particle to enter the MMI-WG, such that the emission light in the MMI-WG propagates in a direction away from the input end; generating, by the sensor, data based on the detected scattered light, wherein the data indicates an intensity of the scattered light; and determining, by the one or more processors, based on the intensity of the scattered light indicated by the data generated by the sensor, an identity of the particle.

In some embodiments, a non-transitory computer readable storage medium is provided, the non-transitory computer readable storage medium storing instructions configured to be executed by one or more processors of a particle identification system comprising an excitation light source, a sensor, and a multi-mode interference waveguide (MMI-WG), the instructions configured to cause the system to: excite, by the excitation light source, a particle to cause the particle to emit emission light; detect, by the sensor, scattered light that scattered through a lateral surface of the MMI-WG, wherein the MMI-WG comprises: an input end; the lateral surface; and an input port disposed on the input end of the MMI-WG and configured to guide the emission light emitted from the particle to enter the MMI-WG, such that the emission light in the MMI-WG propagates in a direction away from the input end; generate, by the sensor, data based on the detected scattered light, wherein the data indicates an intensity of the scattered light; and determine, by the one or more processors, based on the intensity of the scattered light indicated by the data generated by the sensor, an identity of the particle.

In some embodiments, any one or more of the features or aspects of any one or more of the embodiments set forth above may be combined with one another, and/or with other features or aspects of any method, system, technique, or device disclosed herein.

### BRIEF DESCRIPTION OF THE DRAWINGS

FIGS. 1A and 1B depict views of a system for spectrometry and particle identification using out-of-plane imaging of MMI-WG scattering, in accordance with some embodiments.

FIG. 1C depicts a view of a system for spectrometry and particle detection using out-of-plane imaging of MMI-WG scattering, in accordance with some embodiments.

FIG. 2 depicts three spatial interference patterns formed in an MMI-WG using different wavelengths of light, in accordance with some embodiments.

FIG. 3 depicts a method for spectrometry and optional particle identification using out-of-plane imaging of MMI-WG scattering, in accordance with some embodiments.

FIG. 4 depicts a view of a system for spectrometry and particle detection using multiple MMI-WGs arranged in parallel, in accordance with some embodiments.

FIG. 5 depicts a schematic diagram of a computer, in accordance with some embodiments.

### DETAILED DESCRIPTION

Disclosed herein are systems and techniques for MMI-waveguide based spectrometry and for particle-identification based on said spectrometry.

Light of one or more unknown wavelengths may be coupled into MMI-WG and allowed to propagate through the waveguide to form spatial interference patterns therein. As the propagating light scatters out of the top and/or bottom of the MMI-WG (e.g., a broad face of the MMI-WG), the scattered light may be detected by one or more out-of-plane image sensors. Image data based on the scattered light may indicate the intensity of the scattered light at various spatial locations on the top or bottom face of the MMI-WG. The scatter intensity data may then be analyzed by the system in order to determine, based on the intensity of the scattered light at one or more locations on the MMI-WG, the spectrum of the light propagating through the MMI-WG. In some embodiments, a spatial intensity pattern of the scattered light may be used to determine the spectrum (including one or more wavelengths) of the light propagating in the MMI-WG. In some embodiments, the spatial intensity of the scattered light at a single spatial location (or at a finite plural number of spatial locations) on the MMI-WG may be used to determine the spectrum of the light propagating in the MMI-WG.

The spectrometry devices and techniques described herein may be used for particle identification. For example, light emitted from a particle may be coupled into an MMI-WG. The spectrum of the emitted light may then be determined, based on light scattered out of the MMI-WG, and the determined spectrum of emitted light may be used to determine an identity of the particle. For example, the identity of fluorescent particles and/or quantum dots and/or scattering particles that emit or scatter light at characteristic emission wavelengths may be determined.

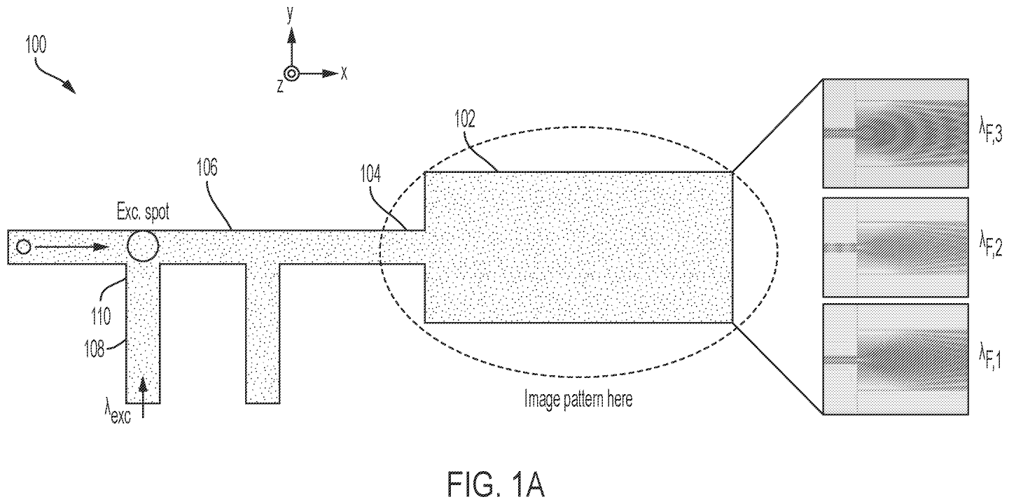

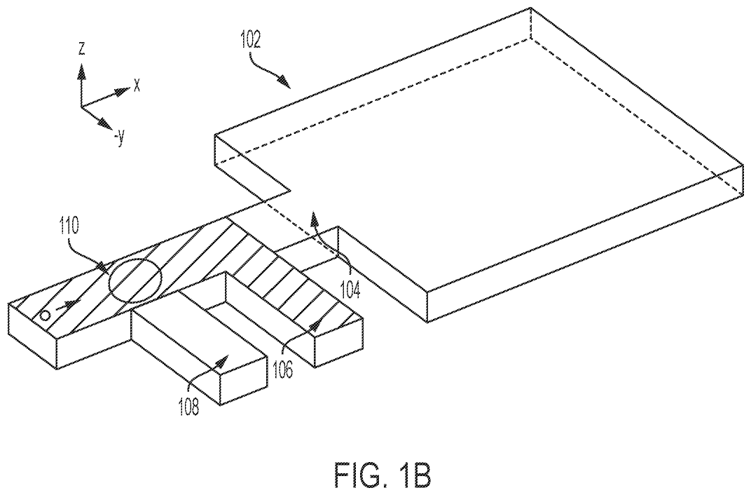

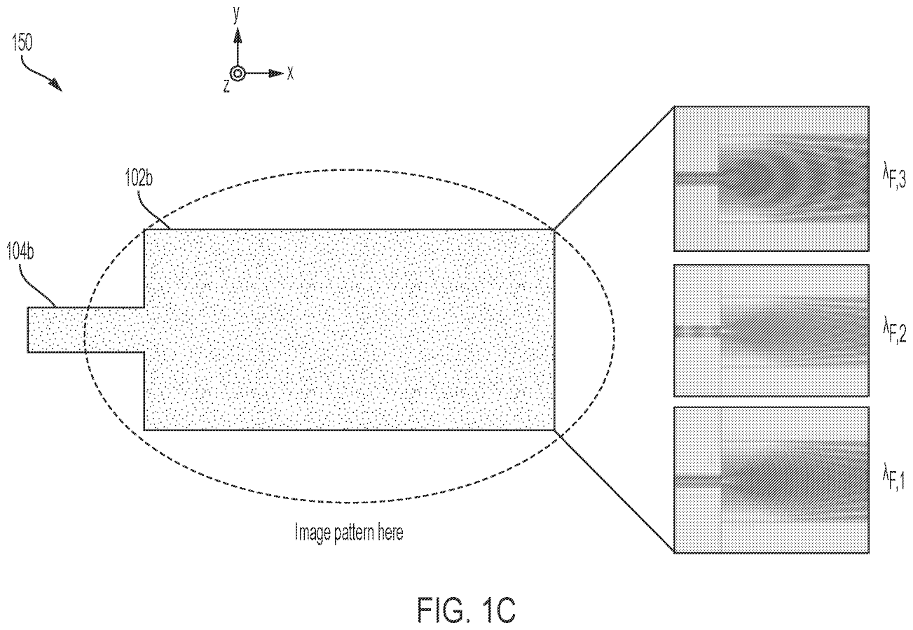

FIGS. 1A and 1B depict views of a system 100 for spectrometry and particle identification using out-of-plane imaging of MMI-WG scattering, in accordance with some embodiments. In some embodiments, system 100 may be implemented as a “chip-scale” spectrometer.

FIG. 1A shows a plan view of system 100, while FIG. 1B shows a perspective view of system 100. In both FIGS. 1A and 1B, an x axis direction, y axis direction, and z axis direction are illustrated. In FIG. 1A, the positive x axis direction and y axis direction are illustrated by arrows, with the positive z axis direction pointing out of the page. In FIG. 1B, the positive x axis direction, negative y axis direction, and positive z axis direction are illustrated by arrows.

As shown in FIGS. 1A and 1B, system 100 may include MMI-WG 102, which may be an MMI-WG comprised of comprising one or more of: silicon, silicon oxide, silicon dioxide, silicon nitride, silicon oxynitrides, other oxides such as tantalum oxide or titanium oxide, polymers, polyimides, liquids, and/or III-V semiconductors such as GaN or GaAs MMI-WG 102 may be a solid-core waveguide and/or a liquid-core waveguide. MMI-WG 102 may comprise flexible materials to enable variation of its dimensions. In liquid-core embodiments, an index of refraction of MMI-WG 102 may be tunable for example by exchanging the fluid in the core of MMI-WG 102. MMI-WG 102 may have an index of refraction of greater than or equal to 1.2, 1.3, 1.4, 1.5, 1.6, or 1.7. MMI-WG 102 may have an index of refraction of less than or equal to 1.2, 1.3, 1.4, 1.5, 1.6, or 1.7. MMI-WG 102 may have an index of refraction of between 1.2 and 1.6. MMI-WG 102, for example in some embodiments in which MMI-WG includes a solid core, may have an index of refraction of greater than or equal to 1.2, 1.4, 1.6, 2, 3, 4, or 5. MMI-WG 102, for example in some embodiments in which MMI-WG includes a solid core, may have an index of refraction of less than or equal to 1.2, 1.4, 1.6, 2, 3, 4, or 5. MMI-WG 102, for example in some embodiments in which MMI-WG includes a solid core, may have an index of refraction of between 1.4 and 4. MMI-WG 102 may comprise one or more materials and/or features (e.g., scattering centers, defects, and/or surface defects) that are selected to encourage scatter of light through a top face or bottom face of MMI-WG 102, as described below.

As shown, MMI-WG 102 may have a rectangular prism (cuboid) shape, such that it may comprise six faces.

MMI-WG 102 may be bound on its ends by an input end face (the leftmost face in FIGS. 1A and 1B) and an output end face (the rightmost face in FIGS. 1A and 1B), each of which are in a y-z plane in FIGS. 1A and 1B as illustrated. MMI-WG 102 may have a length between its the input end face and its output end face (e.g., an x-directional length) of greater than or equal to 50 μm, 100 μm, 250 μm, 500 μm, 750 μm, 1 mm, 5 mm, 1 cm, 2 cm, 3 cm, 4 cm, or 5 cm. MMI-WG 102 may have a length between its the input end face and its output end face (e.g., an x-directional length) of less than or equal to 50 μm, 100 μm, 250 μm, 500 μm, 750 μm, 1 mm, 5 mm, 1 cm, 2 cm, 3 cm, 4 cm, or 5 cm. Light may be coupled into MMI-WG 102 via input port 104, which may be disposed on the input end face of MMI-WG 102. Light coupled into MMI-WG 102 may propagate from the input end toward the output end. (While the output end is referred to as an output end, MMI-WG 102 may or may not have one or more output ports, for coupling light out of MMI-WG 102, disposed on its output end face.)

MMI-WG 102 may be bound on its sides by two side faces, each of which are in an x-z plane in FIGS. 1A and 1B as illustrated. MMI-WG 102 may have a width between its the side faces (e.g., a y-directional width) of greater than or equal to 250 nm, 500 nm, 750 nm, 1 μm, 5 μm, 10 μm, 50 μm, 100 μm, 500 μm, or 1 mm. MMI-WG 102 may have a width between its the side faces (e.g., a y-directional width) of less than or equal to 250 nm, 500 nm, 750 nm, 1 μm, 5 μm, 10 μm, 50 μm, 100 μm, 500 μm, or 1 mm. As light coupled into MMI-WG 102 propagates from input port 104 toward the output end face, the light may undergo internal reflection off of the two side faces and therefore form constructive and destructive interference patterns in the x-y plane.

MMI-WG 102 may be bound on its top and bottom by a top face (the topmost face in FIG. 1B) and a bottom face (the bottommost face in FIG. 1B), each of which are in an x-y plane in FIGS. 1A and 1B as illustrated. MMI-WG 102 may have a height between its the top and bottom faces (e.g., a z-directional height) of greater than or equal to 50 nm, 100 nm, 250 nm, 500 nm, 750 nm, 1 μm, 2 μm, 3 μm, 4 μm, 5 μm, and 6 μm. MMI-WG 102 may have a height between its the top and bottom faces (e.g., a z-directional height) of less than or equal to 50 nm, 100 nm, 250 nm, 500 nm, 750 nm, 1 μm, 2 μm, 3 μm, 4 μm, 5 μm, and 6 μm. As light coupled into MMI-WG 102 propagates from input port 104 toward the output end face, some amount of the light may scatter through the top and/or bottom surface of MMI-WG 102.

In some embodiments, the top face, bottom face, and/or either side face may be referred to as a “lateral surface.” It may be understood that a lateral surface of an MMI-WG may be any of the surfaces of the MMI WG aside from the input end face and the output end face. A lateral surface of an MMI-WG may be perpendicular to the input end face and/or the output end face of the MMI-WG.

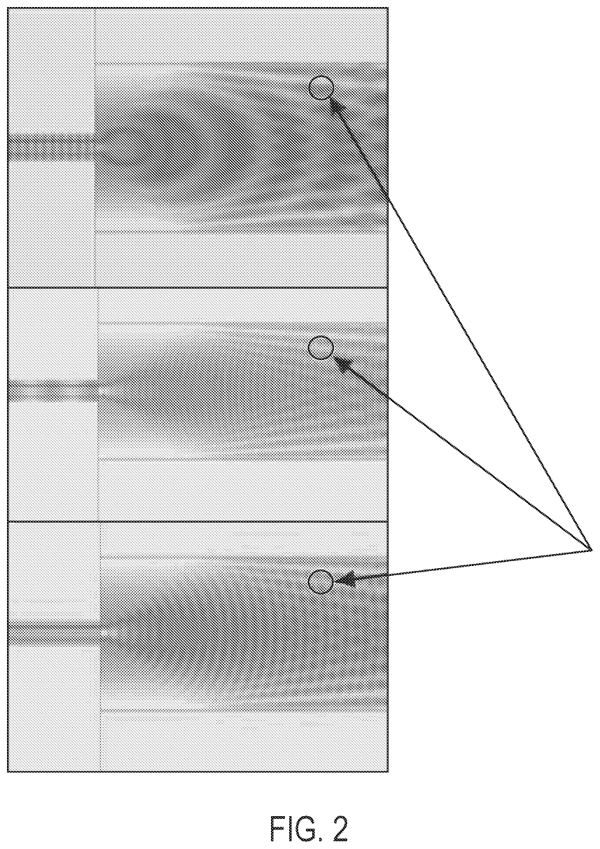

The intensity of scattered light at a given location on the top and/or bottom surface of MMI-WG 102 may be affected by the interference patterns formed due to the different propagation constants of the optical modes of MMI-WG 102 (as described above). The inset image on the right side of FIG. 1A show three spatial interference patterns, as they may be viewed from through the top surface of MMI-WG 102, formed by three different wavelengths of light. (The same three spatial interference patterns formed in MMI-WG 102 are shown in FIG. 2, with additional annotation showing an area at which one pattern has a high intensity and the other two patterns have a low intensity.) As shown, the three spatial interference patterns are spatially different from one another, with their regions of highest intensity and lowest intensity being located at different x-y locations, despite being formed in the same MMI-WG. As described herein, differences in spatial intensity of scattered light, as shown for example by patterns such as these, may be analyzed by system 100 (e.g., by one or more computer processors) in order to determine the spectrum of the light propagating through MMI-WG 102.

In addition to MMI-WG 102, system 100 may include an image sensor configured to collect light that scatters out of MMI-WG 102 through either the top or bottom surface of MMI-WG 102. In some embodiments, the image sensor may be disposed above or below MMI-WG 102 (e.g., in the positive or negative z direction) such that light that scatters out of the top or bottom surface of MMI-WG 102 may be transmitted directly (e.g., through air or through vacuum) to the image sensor. In some embodiments, one or more optical elements such as lenses, fibers, or the like, may be disposed between MMI-WG 102 and the sensor, such that the scattered light that scatters through the top or bottom surface of MMI-WG 102 may pass through the one or more intermediate optical elements and be transmitted to the sensor. In some embodiments, the image sensor may be in direct physical contact with the top or bottom surface of MMI-WG 102, such that light that scatters through the top or bottom surface of MMI-WG 102 may be incident on the image sensor without passing through air, a vacuum, or any intermediate optical elements.

In some embodiments, the image sensor may include, for example, one or more CCD cameras and/or APD arrays. The image sensor may be configured to collect image data in one or more color channels. The image data generated by the sensor may represent intensity of the light (in one or more wavelengths) that is collected at one or more spatial locations of the top or bottom surface of MMI-WG 102. The image sensor may collect image data from a single or multiple regions (e.g., a single or multiple predefined patches) of the top or bottom face of MMI-WG 102, or it may collect image data from the entire top or bottom surface of MMI-WG 102. In some embodiments, the image data generated by the sensor may comprise a two-dimensional image of the top or bottom surface of MMI-WG 102.

System 100 may further comprise one or more computer processors, which may be located locally and/or remotely to other components of system 100 described herein. The one or more processors may be communicatively coupled to the image sensor of system 100 and may be configured to receive the image data generated by the image sensor. Based on the received image data—e.g., image data representing spatial intensity of light scattered through the top face or bottom face of MMI-WG 102—the one or more processors may determine a spectrum of light traveling through MMI-WG 102. In some embodiments, the one or more processors may apply one or more image processing algorithms to the received image data, for example including one or more edge detection, pattern recognition, machine learning, or other image analysis techniques. The one or more image processing techniques may, for example, include matching a detected spatial intensity pattern visible in the image data to a predefined spatial pattern that characteristic of a certain wavelength or wavelengths of light. Additionally or alternatively, the one or more image processing techniques may, for example, include matching a detected intensity at a predefined spatial region to a wavelength or wavelengths of light that is/are known (for example based on a priori knowledge about characteristics of MMI-WG 102) to be associated with certain region or regions of intensity. In this manner, the system may determine, based on patterns and/or local intensity data of the light scattered through the top or bottom face of MMI-WG 102, the spectrum (including one or more wavelengths) of light propagating through MMI-WG 102.

The one or more processors may accordingly generate output data indicating the determined spectrum (e.g., wavelength or wavelengths) of light, and said output data may be stored, displayed, transmitted, and/or used to trigger one or more automated system functionalities.

In some embodiments, one or more characteristics of MMI-WG 102 may be configured to optimize scattering of light through the top face or bottom face of MMI-WG 102. For example, one or more coatings, depositions, chemical treatments, and/or etchings may be applied to all or part of the top surface or bottom surface of MMI-WG 102 to uniformly or spatially-selectively increase and/or decrease scattering of light through the surface. For example, a patterned treatment may be applied to one or more locations of the surface to selectively increase light transmission at those locations.

Locations on the top face or bottom face of MMI-WG 102 at which treatments are applied to selectively enhance transmission of scattered light may be chosen based on knowledge of the spatial interference patterns that will be formed by certain wavelengths of light. For example, if it is known that one or more wavelengths of light will be coupled into MMI-WG 102 (e.g., one or more wavelengths of light that are emitted from one or more known fluorescent particles and/or known quantum dots and/or particles that scatter light via Rayleigh or Raman scattering), then locations at which those wavelengths of light will form constructive interference patterns may be chosen for enhancement of scatter. Locations may be chosen for enhancement of scatter at which only certain wavelengths of light—but not others—to be coupled into MMI-WG 102 may produce constructive interference. For example, FIG. 2 shows three spatial interference patterns formed in an MMI-WG using different wavelengths of light, in accordance with some embodiments. As shown by the area highlighted by the circles and the three arrows, the same location in the same MMI-WG may have a high intensity for one wavelength of light and may not have a high intensity for other wavelengths of light. In the example shown, the wavelength of light in the top diagram has a high intensity at the highlighted location, while the wavelengths of light in the middle and bottom diagrams do not have high intensities at the (same) highlighted location. Thus, a location with a high intensity for a particular wavelength and low intensity for other wavelengths, such as the highlighted location in FIG. 2, may be selected for application of a treatment to enhance scatter at that location.

In addition to determination of wavelength(s) alone, system 100 may also be used to determine particle identity based on the determination of a spectrum (e.g., wavelength or wavelengths) of light being transmitted through MMI-WG 102. As shown in FIGS. 1A and 1B, system 100 may include particle channel 106 and excitation waveguide 108. Particle channel 106 may be a channel configured to hold a fluid (e.g., a liquid) therein such that one or more particles may be suspended in said liquid. Excitation waveguide 108 may be a waveguide configured to guide excitation light to be incident upon a particle in particle channel 106. As shown, particle channel 106 and excitation waveguide 108 may intersect an excitation spot 110. When a particle, such as a fluorescent particle or a quantum dot or a particle that scatters light via Rayleigh or Raman scattering, is excited by the excitation light while the particle is in excitation spot 110, the particle may be caused to emit emission light. The emission light may be coupled into input port 104 (e.g., by one or more suitable intermediate optical elements), such that the emission or scattered light may then propagate through MMI-WG 102.

In some embodiments, any other suitable physical arrangement (e.g., alternatively or additionally to using a particle channel and/or an excitation waveguide) may be used to excite a particle such that it emits emission or scatter light that is coupled into MMI-WG 102. For example, while excitation light in FIGS. 1A and 1B that is incident on excitation spot 110 is shown as traveling in a y axis direction, the excitation light may be incident on a particle from any direction (e.g., side, bottom, and/or top).

Once the emission light from the particle is coupled into MMI-WG 102, the wavelength(s) of the emission light may be determined based on spatial intensity data gathered by imaging of the scattering of the emission light through the top face or bottom face of MMI-WG 102, as described above. Following determination of the wavelength(s) of the emission light, the one or more processors of system 100 may then determine, based on the determined wavelength(s) of the emission light, the identity of the particle that emitted the emission light. For example, the system may match the determined wavelength(s) to a priori knowledge regarding characteristic emission wavelengths for different fluorophores and/or different quantum dots.

The system may generate output data that indicates the determined identity for the particle, and said output data may be stored, displayed, transmitted, and/or used to trigger one or more automated system functionalities.

In some embodiments, the spectrometry and/or particle-identification systems and methods described herein may be used for multiplexing applications, for example in which particles emitting in different wavelengths all emit light into the same MMI-WG. The system may be able to monitor scattered light that emits through the top or bottom face of the MMI-WG over time and thus determine which particles emitted light at each point in time.

While the arrangement in FIGS. 1A and 1B are shown with a single spot for particle excitation, the system may include multiple spots for particle excitation, each of which may have particle emission light coupled into a single MMI-WG (e.g., MMI-WG 102). In some embodiments, particles may flow (e.g., in a particle channel) past multiple different emission spots each configured to excite the particles with a different wavelength of excitation light. Thus, the system may be used to detect emission light, identify the wavelength(s) of emission light, and determine particle identity for a plurality of different excitation spots.

In some embodiments, system 100 may be configured to block, filter, or remove one or more wavelengths of scattered light. In some embodiments, a physical mask may be disposed on top (or bottom) of MMI-WG 102. The mask may be configured in accordance with a known spatial pattern formed by one or more wavelengths for which the user does not wish to collect light. For example, the mask may be configured to block scattered light at one or more locations where it is known that light of an excitation wavelength (e.g., used to excite a particle) will scatter, while transmitting light at one or more locations where it is known that light of an emission wavelength (e.g., emitted by a particle) will scatter. In some embodiments, a spectral filter may be used to block light of one or more wavelengths (e.g., excitation wavelengths), thereby preventing them from being collected by the image sensor. In some embodiments, image post-processing may be used to digitally remove (or compensate for) light at one or more locations that are known to be associated with one or more wavelengths (e.g., excitation wavelengths), thereby allowing intensity data attributable to unwanted wavelengths to be collected by the image sensor but to nonetheless be removed or compensate for before analyzing the remaining intensity data attributable to a spectrum or wavelength of interest.

In some embodiments, system 100 may be configured to allow for a refractive index of MMI-WG 102 to be varied, including by being automatically varied by one or more control devices of system 100. In some embodiments, time-dependent variation of one or more properties (e.g., index of refraction, dimensions) of MMI-WG 102 may be used.

For example, MMI-WG 102 may be provided as a liquid-core waveguide, and liquid in the core of MMI-WG 102 may be changed (e.g., removed and replaced with another liquid) to a liquid with a different index of refraction, thereby resulting in the formation of different patterns for the same wavelengths. Additionally or alternatively, MMI-WG 102 may be provided as a solid-core waveguide that includes a material with a non-zero electro-optic coefficient, such that the refractive index can be modified by applying an electrical voltage across MMI-WG 102.

In some embodiments, system 100 may be configured to allow for one or more dimensions of MMI-WG 102 to be varied, including by being automatically varied by one or more control devices of system 100. For example, MMI-WG 102 may comprise one or more flexible materials (e.g. PDMS), and pressure may be applied to one MMI-WG 102 (e.g., by pressurizing one or more cavities adjacent to MMI-WG 102) in order to cause MMI-WG 102 to spatially deform, thereby resulting in the formation of different patterns for the same wavelengths.

When one or more properties of MMI-WG 102 are varied, additional data sets for the same wavelength may be generated, which may result in more accurate data analysis and improved performance, such as faster readout and/or increased spectral resolution. Additionally or alternatively, formation of secondary images that are wavelength-shifted and/or amplified using suitable optical elements and particles may be used.

In some embodiments, one or more optically active particles may be added to a top face or bottom face of MMI-WG 102, or may be disposed inside MMI-WG 102 (e.g., in the case of a liquid-core waveguide), in order to modify the image in a desired way. For example, deposition of fluorescent particles or up-conversion particles on the surface of MMI-WG 102 may shift the scattered light pattern to a different wavelength for detection.

It should be understood that, while system 100 is shown as including an MMI-WG configured such that input light from a one or more fluidic channels and/or from one or more particles may be coupled in to the MMI-WG, the techniques described with respect to system 100 for collection and analysis of scattered light may be applied to MMI-WG arrangements in which the input light is provided from any suitable source (including sources other than particles and other than fluidic channels). FIG. 1C shows a view of a system 150 for spectrometry and particle detection using out-of-plane imaging of MMI-WG scattering, in accordance with some embodiments. System 150 and its components may share any one or more characteristics in common with system 100 and its corresponding components; the embodiment of system 150 shown in FIG. 1C shows coupling of light into MMI-WG 102b via input port 104b wherein the light coupled in to MMI-WG 102b may come from a source other than a liquid channel.

It should further be understood that, while the examples in FIGS. 1A-1C primarily contemplate light that was coupled into an MMI-WG scattering out of the top or bottom surface of the MMI-WG, the principles disclosed herein may also apply to embodiments in which the light coupled into the MMI-WG excites particles in the MMI-WG to emit emission light, and the emission light is transmitted out of the top or bottom surface of the MMI-WG. A spatial intensity pattern of the emission light may then be analyzed in order to determine one or more wavelengths of the excitation light that was coupled into the MMI-WG. This principle may be applied, for example, when an MMI-WG includes a liquid core with fluorescent particles in suspension.

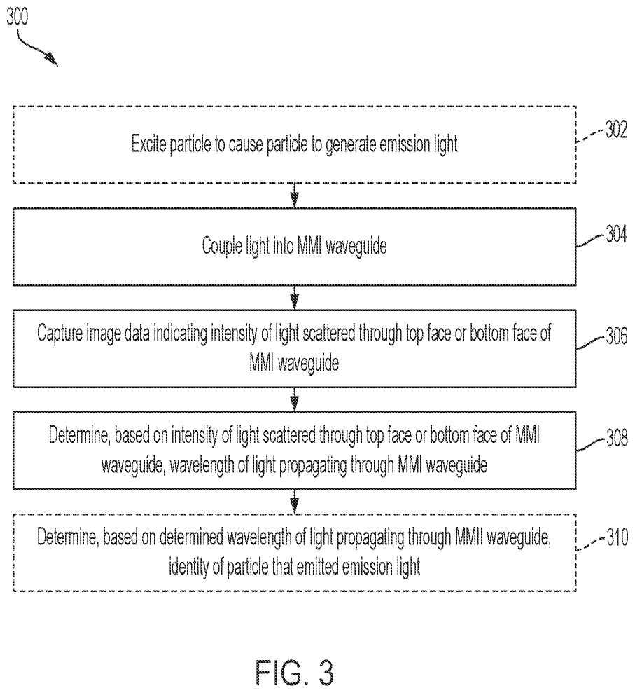

FIG. 3 depicts a method 300 for spectrometry and optional particle identification using out-of-plane imaging of MMI-WG scattering, in accordance with some embodiments. Method 300 may be performed using one or more of the systems described herein, such as system 100 described above. Method 300 may be combined, in whole or in part, with all or part of any other techniques described herein.

At block 302, in some embodiments, a particle is excited with excitation light, thereby causing cause the particle to generate emission light. For example, a particle disposed in particle channel 106 may be excited by excitation light that is directed through excitation waveguide 108. The emission light from the excited particle may then travel toward and into MMI-WG 102

At block 304, in some embodiments, light is coupled into an MMI-WG. For example, the emission light from the particle at block 302 may be coupled into MMI-WG 102 via input port 104. In some embodiments, light from any other source, including light that was not emitted from an excited particle, may be coupled into the MMI-WG.

At block 306, in some embodiments, image data is captured by an image sensor, wherein the image data indicates the intensity of light that has scattered, out-of-plane, out of the MMI-WG, e.g., through the top face or bottom face of the MMI-WG. For example, a two-dimensional image showing the intensity of the scattered light at different locations on the top face or bottom face of the MMI-WG, and thereby showing a spatial intensity pattern of the scatter light, may be captured.

At block 308, in some embodiments, the system may determine, based on the image data representing the intensity of the scattered light, a wavelength or wavelengths of the light propagating through the MMI-WG. The system may be configured to analyze intensity data for a single location or for a plurality of locations. The system may be configured to analyze spatial intensity data representing a spatial intensity pattern. One or more processors of system may apply one or more image analysis techniques, pattern recognition techniques, pattern matching techniques, and/or other algorithms to the image data in order to determine, based on the spatial intensity data, the wavelength(s) of the light in the MMI-WG. In this manner, the system may determine the wavelength(s) of the light in the MMI-WG based on the spatial interference pattern as observed from out-of-plane of the MMI-WG.

At block 310, in some embodiments, the system may determine, based on the determined wavelength(s) of the light in the MMI-WG, an identity of the particle that emitted the emission light that propagated through and scattered out of the MMI-WG. One or more processors of the system may determine a correspondence (e.g., a match or a nearest fit) of the determined wavelength(s) to a particle identity (e.g., a particle type) that is known to emit light of a corresponding wavelength or wavelengths, and the system may thereby determine that the particle is of that identity.

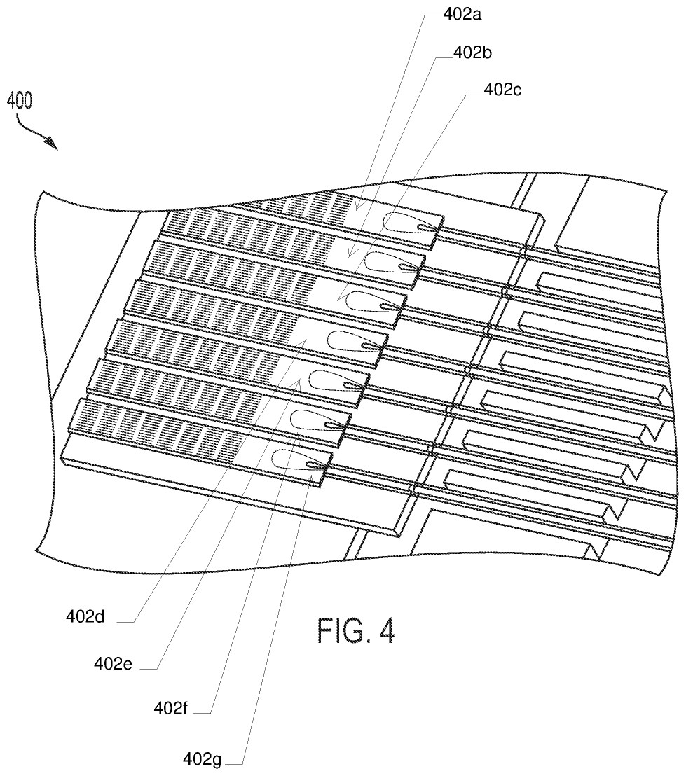

FIG. 4 depicts a view of an exemplary system 400 including an array of two or more MMI-WGs. For instance, as shown, system 400 may include a plurality of MMI-WGs 402a-402g arranged in parallel, with each of the respective waveguides having an independent input end and associated input port for receiving light into the MMI-WG. Such an arrangement may be useful for observing and spectrally analyzing multiple scenes in parallel, e.g., by guiding light received from separate regions or particles of interest into different respective waveguides for spectral analysis. In various examples, a system with multiple MMI-WGs having separate input ports may be useful for stand-off chemical detection of different areas of interest, analyzing different regions of the sky in astronomy, or for biosensors that perform parallel analyses of scattered light for particle detection. In some embodiments, each of the MMI-WGs could be analyzed on a separate channel, allowing for independent spectral analyses of light scattered in each of the MMI-WGs. Such an arrangement could be used for, e.g., multiplexed detection and identification of fluorescent particles, quantum dots, and/or particles that scatter light via Rayleigh or Raman scattering.

In another examples, a single input port may fork into multiple MMI-WGs (e.g., by a y-splitter or by one or more other suitable optical splitting components), allowing for parallel analysis of the same input light signal. Each spectrometer may be independently configured to conduct a different spectral analysis on the scattered light in a respective MMI-WG. For instance, a first MMI spectrometer could perform a broad spectral analysis on a spatial interference pattern formed by multiple wavelengths of light, for example as described with respect to FIG. 1A, while another MMI spectrometer section could perform a large scatter signal analysis of light at a particular wavelength, for example as described with respect to FIG. 2. In some embodiments, the array of MMI-WGs in system 400 may be used as a biosensor for Raman spectrometry, with one MMI-WG providing a full spectrum analysis and another waveguide or waveguides performing an analysis of signals at specific Raman peak wavelengths of the scattered light. In some embodiments, one MMI-WG may be optimized for the spectral analysis of visible light wavelength ranges, while another spectrometer may be optimized for spectral analysis of infrared wavelength ranges. Optionally, the plurality of MMI spectrometers could be arranged on a single chip.

In some embodiments, alternatively to or in addition to providing multiple MMI-WGs in parallel, multiple MMI-WGs may be provided in sequence with one another, such that output light from one MMI-WG may be coupled into an input port of a subsequent MMI-WG. Scatter patterns from the in-sequence MMI-WGs may be collected by one or more out-of-plane image sensors and may be analyzed as described herein.

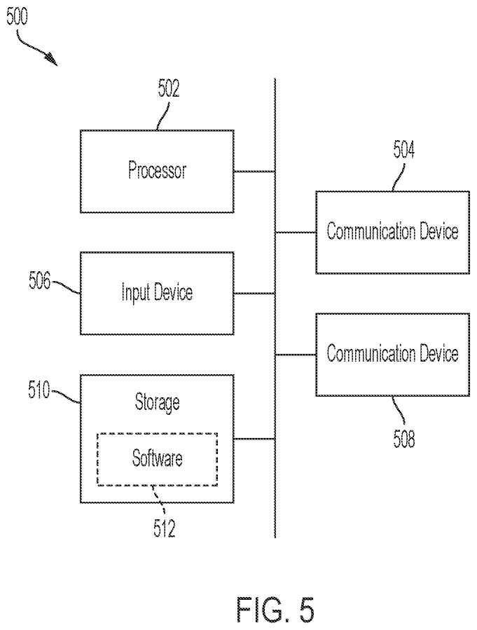

FIG. 5 depicts a schematic diagram of a computer 500, in accordance with some embodiments. Computer 500 can be a component of any system described herein, such as system 100, and/or may be configured to perform all or part of any method described herein, such as all or part of method 300. In some embodiments, computer 500 may be configured to perform processing for a method described herein and/or to serve as a device for displaying and/or controlling a user interface for a system described herein.

Computer 500 can be a host computer connected to a network. Computer 500 can be a client computer or a server. As shown in FIG. 5, computer 500 can be any suitable type of microprocessor-based device, such as a personal computer; workstation; server; or handheld computing device, such as a phone or tablet. The computer can include, for example, one or more of processor 502, input device 506, output device 508, storage 510, and communication device 504.

Input device 506 can be any suitable device that provides input, such as a touch screen or monitor, keyboard, mouse, or voice-recognition device. Output device 508 can be any suitable device that provides output, such as a touch screen, monitor, printer, disk drive, or speaker.

Storage 510 can be any suitable device that provides storage, such as an electrical, magnetic, or optical memory, including a RAM, cache, hard drive, CD-ROM drive, tape drive, or removable storage disk. Communication device 504 can include any suitable device capable of transmitting and receiving signals over a network, such as a network interface chip or card. The components of the computer can be connected in any suitable manner, such as via a physical bus or wirelessly. Storage 510 can be a non-transitory computer-readable storage medium comprising one or more programs, which, when executed by one or more processors, such as processor 502, cause the one or more processors to execute methods described herein, such as all or part of method 300.

Software 512, which can be stored in storage 510 and executed by processor 502, can include, for example, the programming that embodies the functionality of the present disclosure (e.g., as embodied in the systems, computers, servers, and/or devices as described above). In some embodiments, software 512 can be implemented and executed on a combination of servers such as application servers and database servers.

Software 512 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 510, that can contain or store programming for use by or in connection with an instruction execution system, apparatus, or device.

Software 512 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 500 can implement any operating system suitable for operating on the network. Software 512 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A multimode-interferometric spectrometer, comprising:
a multi-mode interference waveguide (MMI-WG), comprising: an input end;
a lateral surface; and
an input port disposed on the input end of the MMI-WG and configured to guide input light to enter the MMI-WG, such that light in the MMI-WG propagates in a direction away from the input end;
a sensor configured to detect scattered light that scattered through the lateral surface of the MMI-WG, and to generate data based on the detected scattered light, wherein the data indicates an intensity of the scattered light; and
one or more processors configured to determine, based on the intensity of the scattered light indicated by the data generated by the sensor, one or more wavelengths of the input light.

2. The multimode-interferometric spectrometer of claim 1, wherein the lateral surface comprises one of a top surface of the MMI-WG and a bottom surface of the MMI-WG.

3. The multimode-interferometric spectrometer of claim 1, wherein the sensor is spaced apart from the lateral surface of the MMI-WG such that the scattered light propagates from the lateral surface of the MMI-WG through air to reach the sensor.

4. The multimode-interferometric spectrometer of claim 1, comprising one or more optical elements configured to guide the scattered light to the sensor.

5. The multimode-interferometric spectrometer of claim 1, wherein:
the sensor comprises a two-dimensional sensor configured to detect the scattered light scattered through the lateral surface of the MMI-WG; and
the data generated by the sensor comprises a two-dimensional image based on the detected scattered light.

6. The multimode-interferometric spectrometer of claim 1, wherein a portion of the lateral surface of the MMI-WG comprises a modified portion that enhances scattering at a location of the modified portion.

7. The multimode-interferometric spectrometer of claim 6, wherein the modified portion comprises one or more of:
an etched portion of the lateral surface; and a layer deposited onto the lateral surface.

8. The multimode-interferometric spectrometer of claim 6, wherein:
input light of a first wavelength scatters at the location with an intensity above a predefined threshold; and
input light of a second wavelength scatters at the location with an intensity below a predefined threshold.

9. The multimode-interferometric spectrometer of claim 6, wherein the sensor is configured to detect the scattered light after scattering through the modified portion of the lateral surface of the MMI-WG.

10. The multimode-interferometric spectrometer of claim 1, wherein determining the one or more wavelengths of the input light comprises determining whether the intensity of the scattered light exceeds a predefined intensity threshold.

11. The multimode-interferometric spectrometer of claim 1, wherein: the data generated by the sensor comprises a two-dimensional image; and
determining the one or more wavelengths of the input light comprises applying a pattern-recognition operation to image.

12. A method, performed at a multimode-interferometric spectrometer comprising a sensor, one or more processors, and a multi-mode interference waveguide (MMI-WG), the method comprising:
detecting, by the sensor, scattered light that scattered through a lateral surface of the MMI-WG, wherein the MMI-WG comprises:
an input end;
the lateral surface; and
an input port disposed on the input end of the MMI-WG and configured to guide input light to enter the MMI-WG, such that light in the MMI-WG propagates in a direction away from the input end;
generating, by the sensor, data based on the detected scattered light, wherein the data indicates an intensity of the scattered light; and
determining, by the one or more processors, based on the intensity of the scattered light indicated by the data generated by the sensor, one or more wavelengths of the input light.

13. A non-transitory computer readable storage medium storing instructions configured to be executed by one or more processors of a multimode-interferometric spectrometer comprising a sensor and a multi-mode interference waveguide (MMI-WG), the instructions configured to cause the spectrometer to:
detect, by the sensor, scattered light that scattered through a lateral surface of the MMI-WG, wherein the MMI-WG comprises:
an input end;
the lateral surface; and
an input port disposed on the input end of the MMI-WG and configured to guide input light to enter the MMI-WG, such that light in the MMI-WG propagates in a direction away from the input end;
generate, by the sensor, data based on the detected scattered light, wherein the data indicates an intensity of the scattered light; and
determine, by the one or more processors, based on the intensity of the scattered light indicated by the data generated by the sensor, one or more wavelengths of the input light.

14. A system for particle identification, comprising:
an excitation light source configured to excite a particle and to cause the particle to emit emission light;
a multi-mode interference waveguide (MMI-WG), comprising: an input end;
a lateral surface; and
an input port disposed on the input end of the MMI-WG and configured to guide the emission light emitted from the particle to enter the MMI-WG, such that the emission light in the MMI-WG propagates in a direction away from the input end;
a sensor configured to detect scattered light that scattered through the lateral surface of the MMI-WG, and to generate data based on the detected scattered light, wherein the data indicates an intensity of the scattered light; and
one or more processors configured to determine, based on the intensity of the scattered light indicated by the data generated by the sensor, an identity of the particle.

15. The system for particle identification of claim 14, wherein the particle comprises a fluorescent molecule.

16. The system for particle identification of claim 14, wherein the particle is fluorescently labeled.

17. The system for particle identification of claim 14, wherein the particle comprises a quantum dot.

18. The system for particle identification of claim 14, wherein the particle is labeled with one or more quantum dots.

19. The system for particle identification of claim 14, wherein the particle scatters light via Rayleigh or Raman scattering.

20. The system for particle identification of any one of claim 14, wherein a particle is bound to a carrier particle.

21. The system for particle identification of claim 14, comprising a fluid channel configured to hold a fluid medium in which the particle is disposed.

22. The system for particle identification of claim 21, wherein the excitation light source is incident on the fluid channel to excite the particle.

23. The system for particle identification of claim 14, wherein determining the identity of the particle comprises:
determining, based on the intensity of the scattered light indicated by the data generated by the sensor, one or more wavelength of the emission light; and
determining, based on the determined one or more wavelengths of the emission light, the identity of the particle.

24. The system of claim 14, wherein the lateral surface comprises one of a top surface of the MMI-WG and a bottom surface of the MMI-WG.

25. The system of claim 14, wherein the sensor is spaced apart from the lateral surface of the MMI-WG such that the scattered light propagates from the lateral surface of the MMI-WG through air to reach the sensor.

26. The system of claim 14, comprising one or more optical elements configured to guide the scattered light to the sensor.

27. The system of claim 14, wherein:
the sensor comprises a two-dimensional sensor configured to detect the scattered light scattered through the lateral surface of the MMI-WG; and
the data generated by the sensor comprises a two-dimensional image based on the detected scattered light.

28. The system of claim 14, wherein a portion of the lateral surface of the MMI-WG comprises a modified portion that enhances scattering at a location of the modified portion.

29. The system of claim 28, wherein the modified portion comprises one or more of: an etched portion of the lateral surface; and
a layer deposited onto the lateral surface.

30. The system of claim 28, wherein:
input light of a first wavelength scatters at the location with an intensity above a predefined threshold; and
input light of a second wavelength scatters at the location with an intensity below a predefined threshold.

31. The system of claim 28, wherein the sensor is configured to detect the scattered light after scattering through the modified portion of the lateral surface of the MMI-WG.

32. The system of claim 23, wherein determining the one or more wavelengths of the input light comprises determining whether the intensity of the scattered light exceeds a predefined intensity threshold.

33. The system of claim 23, wherein: the data generated by the sensor comprises a two-dimensional image; and determining the one or more wavelengths of the input light comprises applying a pattern-recognition operation to image.

34. A method, performed at a particle identification system comprising an excitation light source, a sensor, and a multi-mode interference waveguide (MMI-WG), the method comprising:
exciting, by the excitation light source, a particle to cause the particle to emit emission light;
detecting, by the sensor, scattered light that scattered through a lateral surface of the MMI-WG, wherein the MMI-WG comprises:
an input end;
the lateral surface;
an input port disposed on the input end of the MMI-WG and configured to guide the emission light emitted from the particle to enter the MMI-WG, such that the emission light in the MMI-WG propagates in a direction away from the input end;
generating, by the sensor, data based on the detected scattered light, wherein the data indicates an intensity of the scattered light; and
determining, by one or more processors, based on the intensity of the scattered light indicated by the data generated by the sensor, an identity of the particle.

35. A non-transitory computer readable storage medium storing instructions configured to be executed by one or more processors of a particle identification system comprising an excitation light source, a sensor, and a multi-mode interference waveguide (MMI-WG), the instructions configured to cause the system to:
excite, by the excitation light source, a particle to cause the particle to emit emission light;
detect, by the sensor, scattered light that scattered through a lateral surface of the MMI-WG, wherein the MMI-WG comprises:
an input end;
the lateral surface; and
an input port disposed on the input end of the MMI-WG and configured to guide the emission light emitted from the particle to enter the MMI-WG, such that the emission light in the MMI-WG propagates in a direction away from the input end;
generate, by the sensor, data based on the detected scattered light, wherein the data indicates an intensity of the scattered light; and
determine, by the one or more processors, based on the intensity of the scattered light indicated by the data generated by the sensor, an identity of the particle.
